(19) United States
(12) Patent Application Publication
(10) Pub. No.: US 2015/0107379 A1
(43) Pub. Date: Apr. 23, 2015

(54) FLOW SENSOR MOUNTING APPARATUS

(71) Applicant: Therm-O-Disc, Incorporated, Mansfield, OH (US)

(72) Inventors: Derek J. Rose, Mansfield, OH (US); Yicheng Pan, Lexington, OH (US); Gary D. Dinges, Mansfield, OH (US); Richard E. Welch, Lexington, OH (US); Jared Starling, Mansfield, OH (US); Donald G. Cunitz, Mansfield, OH (US)

(73) Assignee: Therm-O-Disc, Incorporated, Mansfield, OH (US)

(21) Appl. No.: 14/059,734

(22) Filed: Oct. 22, 2013

(51) Int. Cl. G01F 15/18

(52) U.S. Cl. CPC G01F 15/18
USPC 73/866.5

(57) ABSTRACT

A mount includes a sensor that is configured to output data characterizing the environment. A first portion has a receiving portion and a first aperture for receiving the sensor. The receiving portion fixes the sensor to the first portion. A positive location portion is located on the receiving portion and is adapted to receive the sensor. The positive location portion and first portion orient the position and depth of the sensor. A second portion is removably secured to the first portion to form a clamping structure for retaining the sensor.

### FIELD

The present disclosure relates to mounting apparatus for flow sensors and, more particularly, to a pipe mounting clamp for a fluid flow sensor.

### BACKGROUND

This section provides background information related to the present disclosure which is not necessarily prior art.

Sensors are often placed in pipes or other tubing to collect data relating to the level of a fluid, flow rate of a fluid, turbidity of a fluid, and the temperature of a fluid flowing through the tubing. In each of these applications, it is desirable for the sensor to be positioned in a specific location within the tubing. Further, it is desirable for the tubing to be mounted such that mounting and maintenance can be performed in a reliable manner.

Various mounting systems have been developed for mounting sensors to pipes or tubes. Such mounting systems, however, are not effective for repeatedly easily mounting a sensor within the interior space of the pipe or tube such that it places the sensor in the optimal position and location within the flow of fluid carried by the pipe or tube.

Also, sensors often need to be accommodated for mounting within a pipe or tube by including a fitting that is brazed or threaded to the pipe, such as a plumbing tee. Threading of the sensor into a plumbing tee does not allow the desired control of the sensor orientation.

### SUMMARY

This section provides a general summary of the disclosure, and is not a comprehensive disclosure of its full scope or all of its features.

The invention provides an extremely reliable and accurate mounting system for mounting a sensor to tubing. Further, the invention is simple in design and easy to operate, making the accurate results repeatable.

In one aspect, a mount includes a sensor that is configured to output data characterizing the environment. A first portion has a receiving portion and a first aperture for receiving the sensor. The receiving portion fixes the sensor to the first portion. A positive location portion is located on the receiving portion and is adapted to receive the sensor. The positive location portion and first portion orient the position and depth of the sensor. A second portion is removably secured to the first portion to form a clamping structure for retaining the sensor.

In another aspect, a mount includes a sensor that is configured to output data characterizing the environment. A fitting has a through-hole and is configured to receive the sensor. A first positive locator is on the fitting and is adapted to receive a second positive locator on the sensor. A connector has a plurality of outlets for receiving the fitting and a plurality of cylindrical portions. The fitting is fixed within the connector. The first and second positive locators orient the alignment and depth of the sensor within the connector.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a sensor mounted to a cylindrical tube in a sensor mounting clamp in accordance with the present disclosure;

FIG. 2 is a front view of the sensor mounted to the cylindrical tube in the sensor mounting clamp of FIG. 1;

FIG. 3 is a perspective view of the sensor mounted in the sensor mounting clamp of FIG. 1;

FIG. 4 is another perspective view of the sensor mounted in the sensor mounting clamp of FIG. 1;

FIG. 5 is a perspective view of the sensor mounted in the sensor mounting clamp of FIG. 1 with a portion of the cylindrical tube cut away to show a seal and the mounting of the sensor;

FIG. 6 is a perspective view of the sensor mounting clamp of FIG. 1 with the support raised;

FIG. 7 is a perspective view of the sensor mounting clamp of FIG. 1 with the support lowered;

FIG. 8 is a perspective view of a second embodiment of a sensor mounting clamp in accordance with the present disclosure;

FIG. 9a is a perspective view of a sensor mounted to a cylindrical tube in a third embodiment of a sensor mounting clamp in accordance with the present disclosure;

FIG. 9b is another perspective view of the sensor mounted to the cylindrical tube in the sensor mounting clamp of FIG. 9a with a portion of the cylindrical tube cut away to show a seal and the mounting of the sensor;

FIG. 10 is a perspective view of another sensor in a fitting in accordance with the present disclosure;

FIG. 11 is a top perspective view of the sensor in the fitting of FIG. 10 in accordance with the present disclosure;

FIG. 12 is a perspective view of the sensor of FIG. 10 mounted in a fourth sensor mounting clamp in accordance with the present disclosure;

FIG. 13 is a perspective view of another embodiment of a sensor in accordance with the present disclosure;

FIG. 14 is a perspective view of another embodiment of a sensor in accordance with the present disclosure;

FIGS. 15a-15c are charts illustrating the mounting angle sensitivity of a sensor with parallel wings;

FIG. 16 is a chart illustrating the mounting depth sensitivity of a sensor with parallel wings;

FIG. 17a is a chart illustrating the sensitivity of a sensor with a rounded conditioner and an upstream disturbance; and

FIG. 17b is a chart illustrating the sensitivity of a sensor with a parallel wing conditioner and an upstream disturbance.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

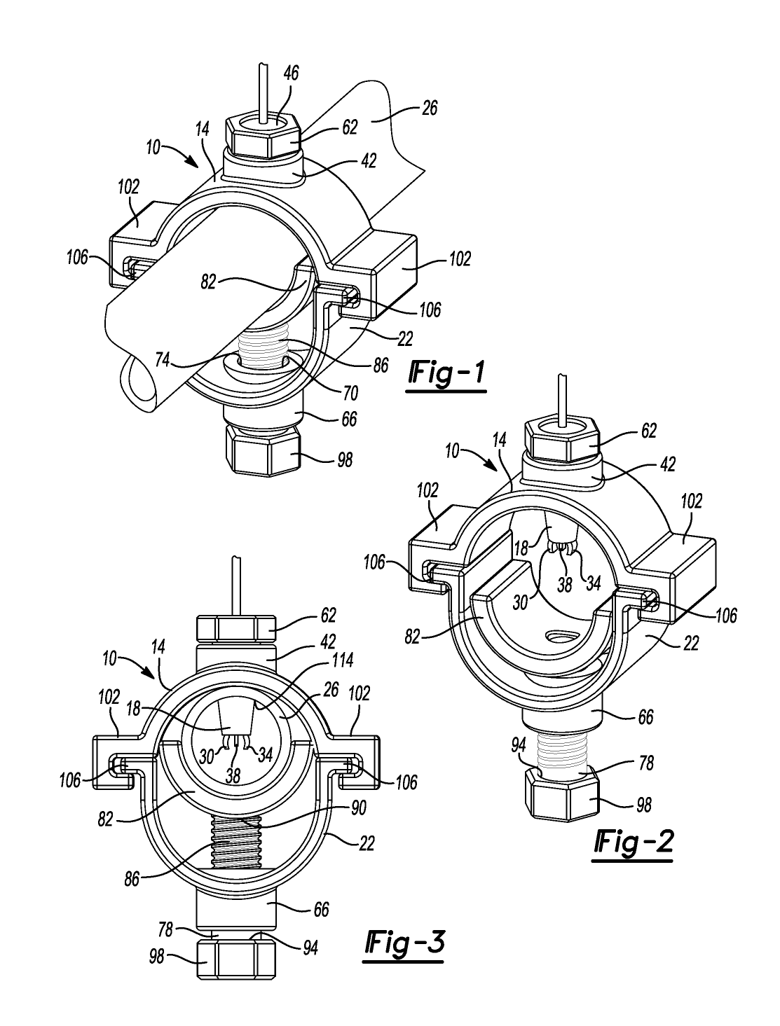

Referring to FIGS. 1-7, a sensor mounting clamp 10 may include a first portion 14 for receiving a sensor 18, and a second portion 22 for retaining the sensor 18 in a cylindrical tube 26. The sensor 18 may be cylindrical in shape and measures a physical quantity of the fluid in the cylindrical tube 26. The sensor 18 converts the physical quantity to a signal which is read by an electrical instrument (not shown). The sensor may be configured to collect flow data (for example only, speed, turbulence, etc.), temperature data, moisture content data, or any other data known by one skilled in the art.

The sensor 18 includes wings 30, 34 and a sensor tip 38 which reads the physical data. When the sensor 18 is installed within the cylindrical tube 26, the wings 30, 34 channel flow of the fluid within the cylindrical tube 26 across the sensor tip 38. This reduces turbulence of the flow across the sensor tip 38 and results in a more accurate reading. The wings 30, 34 may be parallel wings or rounded flow conditioners.

The first portion 14 may be a saddle or concave portion 14 that receives the cylindrical tube 26 and mates with the curved portion of the cylindrical tube 26. The first portion 14 may further include a first receiving portion 42 that may be a cylindrical protrusion 42 extending out of the first portion 14 in a direction away from the cylindrical tube 26. The first receiving portion 42 may also have a cross sectional geometric shape such as a circle, hexagon, octagon, rectangle or any other shape. The hexagon, octagon, and rectangle shapes may be beneficial for gripping the first receiving portion 42 with a tool such as a wrench, vice grips, or pliers.

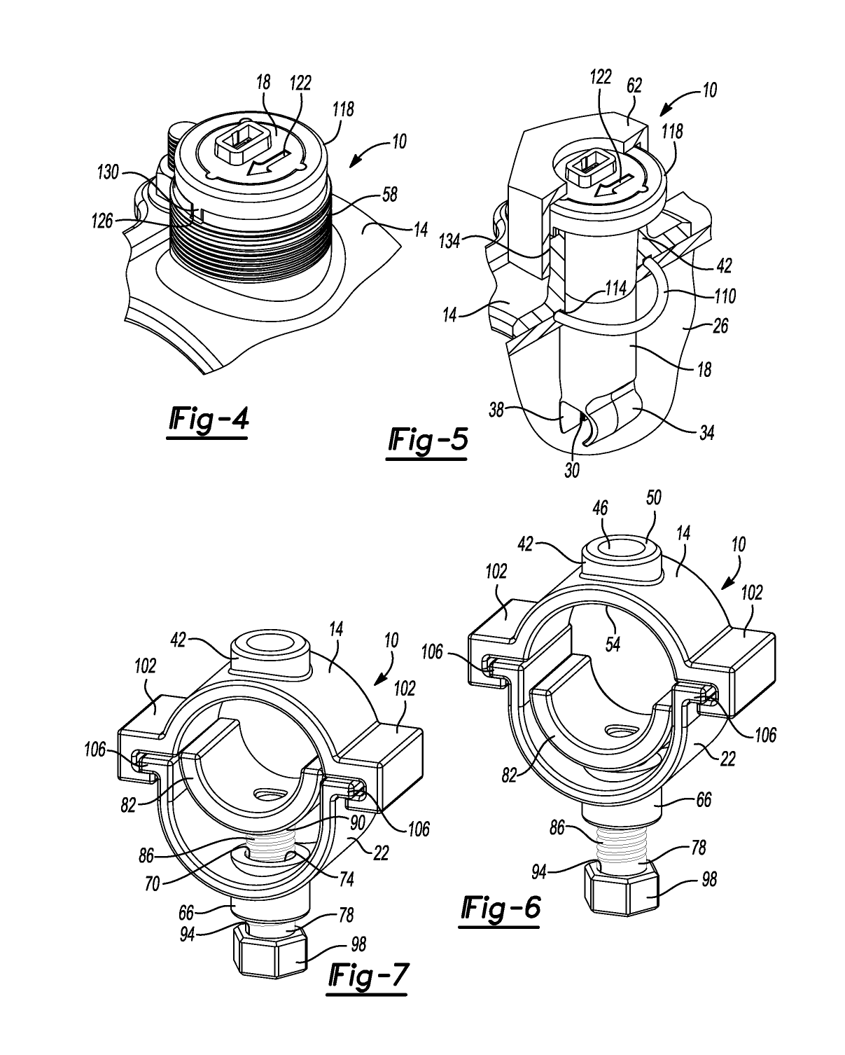

The first receiving portion 42 may include a first aperture 46 extending along the longitudinal axis of the first receiving portion 42 and extending from a top side 50 to an interior wall 54 of the first portion 14, through which the sensor 18 may be received. The first receiving portion 42 may also include a threaded portion 58 for receiving a fastener 62, which may be a nut or other fastener known in the art (FIGS. 4-5).

The second portion 22 may also be a saddle or concave portion 22 that receives the cylindrical tube 26 and retains the sensor 18 in the cylindrical tube 26 by applying a force to the cylindrical tube 26 to maintain its position within the sensor mounting clamp 10. The second portion 22 may include a second receiving portion 66 with a second aperture 70 extending through the second receiving portion 66. The second receiving portion 66 may be a cylindrical protrusion 66 extending out of the second portion 22 in a direction away from the cylindrical tube 26. The second receiving portion 66 may also have a cross sectional geometric shape such as a hexagon, octagon, rectangle or any other shape.

An interior wall 74 of the second aperture 70 in the second receiving portion 66 may be threaded for receiving an adjustment knob 78. The adjustment knob 78 turns about an axis through the center of the adjustment knob 78 and operates to fix the height of a support 82 within the sensor mounting clamp 10. The adjustment knob 78 may be a bolt and further that includes a shaft 86, a proximal end 90 and a distal end 94. The shaft 86 may be threaded along its entire length and engages with the threaded interior wall 74 of the second receiving portion 66. The support 82 may be fixed on the proximal end 90 and a head 98 may be fixed to the distal end 94. The head 98 may have a cross sectional geometric shape of a hexagon, octagon, rectangle, or any other shape. The cross section of the head 98 may have a larger diameter than the cross section of the shaft 86 and may be sized and shaped to engage with a tool such as a wrench, vice grips, pliers, or any other gripping tool.

The first portion 14 and the second portion 22 may engage in a sliding arrangement. The first portion 14 may include a U-shaped portion 102 on each end of the first portion 14 that engages with an L-shaped portion 106 on each end of the first portion. The L-shaped portion 106 slides horizontally between the sides of the U-shaped portion 102 and is vertically fixed within the U-shaped portion 102.

Now referring to FIGS. 4-5, the first receiving portion 42 may include a seal 110 (for example only, an o-ring) that is sealingly engaged between the sensor 18, the first portion 14, and the first receiving portion 42. The seal 110 prevents fluid within the cylindrical tube 26 from leaking through the first aperture 46.

Referring to FIGS. 1-7, during installation, the cylindrical tube 26 is received by the first portion 14. A third aperture 114 in the cylindrical tube 26 is aligned with the first aperture 46 in the first receiving portion 42. The second portion 22 is engaged with the first portion 14 by sliding the L-shaped portions 106 of the second portion 22 within the U-shaped portions 102 of the first portion 14.

The support 82 is then engaged with the cylindrical tube 26 by turning the head 98 on the shaft 86 in a direction that engages the threads on the shaft 86 with the threads on the interior wall 74 of the second aperture 70 and moves the support 82 vertically away from the second aperture 70 and toward the cylindrical tube 26. The head 98 on the shaft 86 is turned until the cylindrical tube 26 engages both the support 82 and the first portion 14.

The sensor 18 is secured within the first aperture 46 in the first receiving portion 42 and the third aperture 114 in the cylindrical tube 26. The sensor 18 is received in the first aperture 46 and sealingly engages with the first receiving portion 42 and the first portion 14 through the seal 110. A sensor head 118 of the sensor 18 may have a larger diameter than the outer diameter of the first receiving portion 42 and may prevent the sensor 18 from being inserted farther into the first aperture 46. An arrow 122 on the sensor head 118 points in the direction of the flow of the fluid within the cylindrical tube 26 to ensure that the sensor 18 is inserted into the first aperture 46 in the correct direction. Further, at least one positive location portion 126 (for example only, a notch) on the first receiving portion 42 engages with at least one tab 130 on the sensor 18 to locate the sensor 18 within the first aperture 46.

Once the sensor 18 is correctly located within the first aperture 46, the fastener 62 (or cap) may be secured over the sensor head 118 to retain the sensor 18 within the first aperture 46. The fastener 62 may prevent the sensor 18 from backing out of the first aperture 46 and retains the vertical placement of the sensor 18 within the cylindrical tube 26. The fastener 62 may be a cap or nut 62 that is threaded on an interior wall 134 and engages with the threaded portion 58 on the first receiving portion 42.

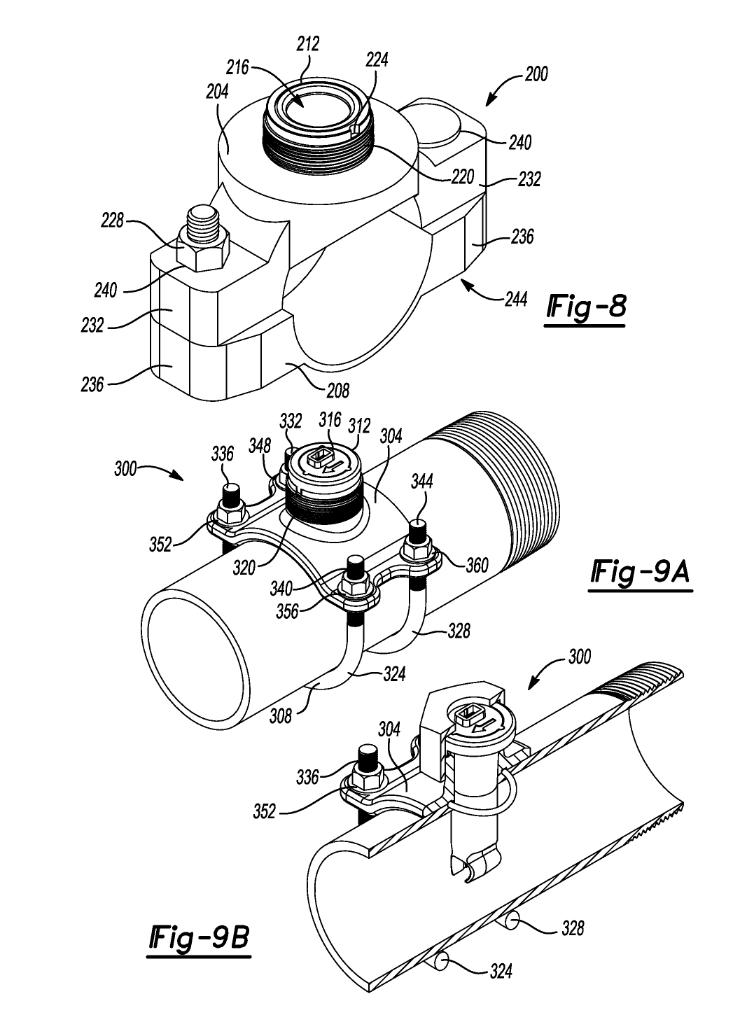

Now referring to FIG. 8, a sensor mounting clamp 200 includes a first portion 204 and a second portion 208 and may generally include the features discussed for sensor mounting clamp 10. The first portion 204 further includes a first receiving portion 212 that receives the sensor 18 as previously discussed. The first receiving portion may be a cylindrical protrusion 212 extending out of the first portion 204 in a direction away from the first portion 204. The first receiving portion 212 may also have a cross sectional geometric shape such as a circle, hexagon, octagon, rectangle or any other shape. The hexagon, octagon, and rectangle shapes may be beneficial for gripping the first receiving portion 204 with a tool such as a wrench, vice grips, or pliers.

The first receiving portion 212 may include a first aperture 216 extending along the longitudinal axis of the first receiving portion 212, through which the sensor 18 may be received. The first receiving portion 212 may also include a threaded portion 220 and a positive location portion 224 (for example, a notch) to locate the sensor 18 within the first aperture 216, similar to the positive location portion 126 and tab 130 previously discussed.

The second portion 208 may be similar to the second portion 22 of sensor mounting clamp 10 with a second receiving portion 66 and a second aperture 70 adapted to receive an adjustment knob 78 with a support 82, or the second portion 208 may be a solid saddle 208 adapted to engage with the cylindrical tube 26 and retain the cylindrical tube 26 to the first portion 204.

The first portion 204 may be fixed to the second portion 208 by a fastener 228. The fastener 228 may be a nut and bolt arrangement or any other fastener known to one skilled in the art. The first portion 204 and second portion 208 each include a plurality of tabs 232, 236. Each tab 232, 236 further includes an aperture 240, 244 extending through the tabs 232, 236. The aperture 240 on the tab 232 of the first portion 204 is coaxial with the aperture 244 on the tab 236 of the second portion 208. The fastener 228 is received within the aligned apertures 240, 244 on the tabs 232, 236 of the first and second portions 204, 208.

Now referring to FIGS. 9a and 9b, a sensor mounting clamp 300 includes a first portion 304 and a second portion 308 and may generally include the features discussed for sensor mounting clamps 10 and 200. The first portion 304 further includes a first receiving portion 312 that receives the sensor 18 as previously discussed. The first receiving portion 312 may be a cylindrical protrusion 312 extending out of the first portion 304 in a direction away from the first portion 304. The first receiving portion 312 may also have a cross sectional geometric shape such as a circle, hexagon, octagon, rectangle or any other shape. The hexagon, octagon, and rectangle shapes may be beneficial for gripping the first receiving portion 304 with a tool such as a wrench, vice grips, or pliers.

The first receiving portion 312 may include a first aperture 316 extending along the longitudinal axis of the first receiving portion 312, through which the sensor 18 may be received. The first receiving portion 312 may also include a threaded portion 320.

The second portion 308 may be a plurality of concave portions 324, 328. The concave portions 324, 328 may be U-shaped bolts with threaded portions 332, 336, 340, 344 on the ends and may be received through a plurality of apertures 348, 352, 356, 360 in the first portion 304. The cylindrical tube 26 is secured to the first portion 304 and the sensor 18 by inserting the cylindrical tube 26 within the concave portions 324, 328, inserting the threaded portions 332, 336, 340, 344 of the concave portions 324, 328 through the plurality of apertures 348, 352, 356, 360 in the first portion 304 and tightening nuts on the ends of the threaded portions 332, 336, 340, 344, securing the concave portions 324, 328 to the first portion 304.

The sensor mounting clamp 300 may be beneficial in cases where the cylindrical tube 26 is tapered, changes sizes frequently, or is textured. The plurality of concave portions 324, 328 can accommodate each of these instances easily.

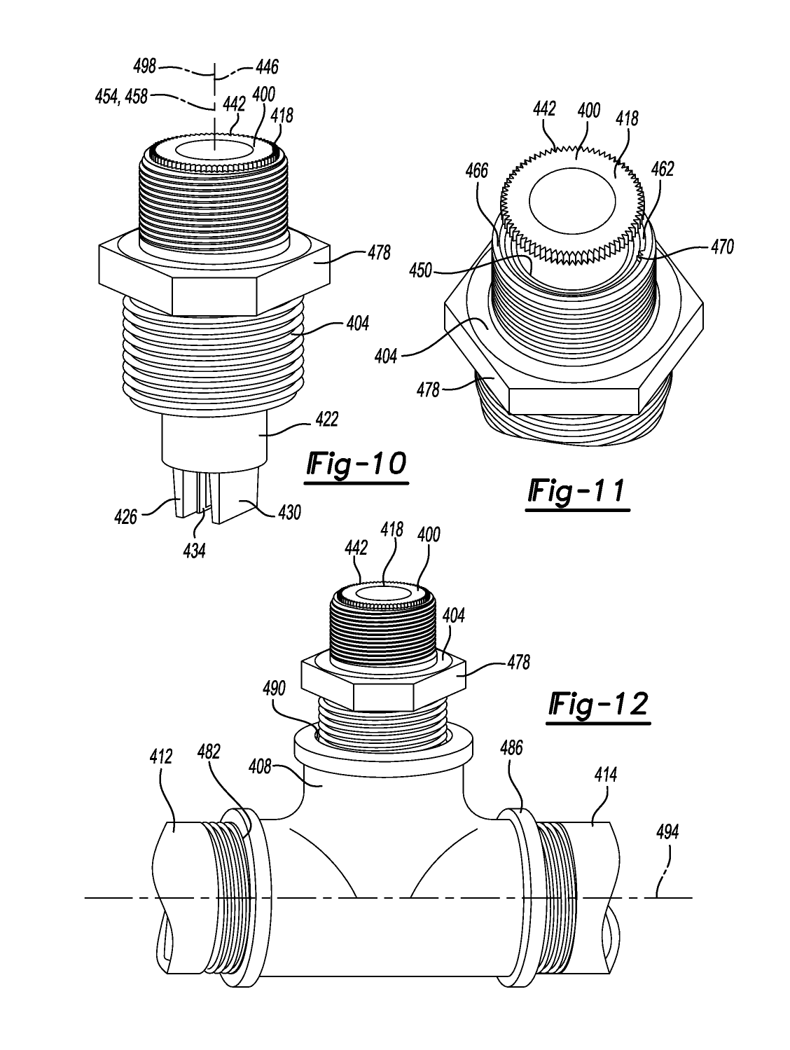

Now referring to FIGS. 10-12, a sensor 400 may be mounted in a fitting 404 and removably installed to a connector 408 that attaches to portions of a cylindrical tube 412, 414. The sensor 400 may include the features of sensor 18. The sensor 400 includes a head 418, a body 422, first and second wings 426, 430 and a sensor tip 434. The head 418 may include positive locators that may be protrusions 442 extending radially away from a longitudinal axis 446 through the center of the sensor 400 or protrusions extending vertically away from the body 422 (as shown in FIG. 14). Protrusions 442 may be in the shape of a gear.

The wings 426, 430 channel flow of the fluid within the cylindrical tube 412, 414 across the sensor tip 434. This reduces turbulence of the flow and results in a more accurate reading. The wings 426, 430 may be parallel wing or rounded flow conditioners. For example, the wings 426, 430 illustrated in FIG. 10 are parallel wings.

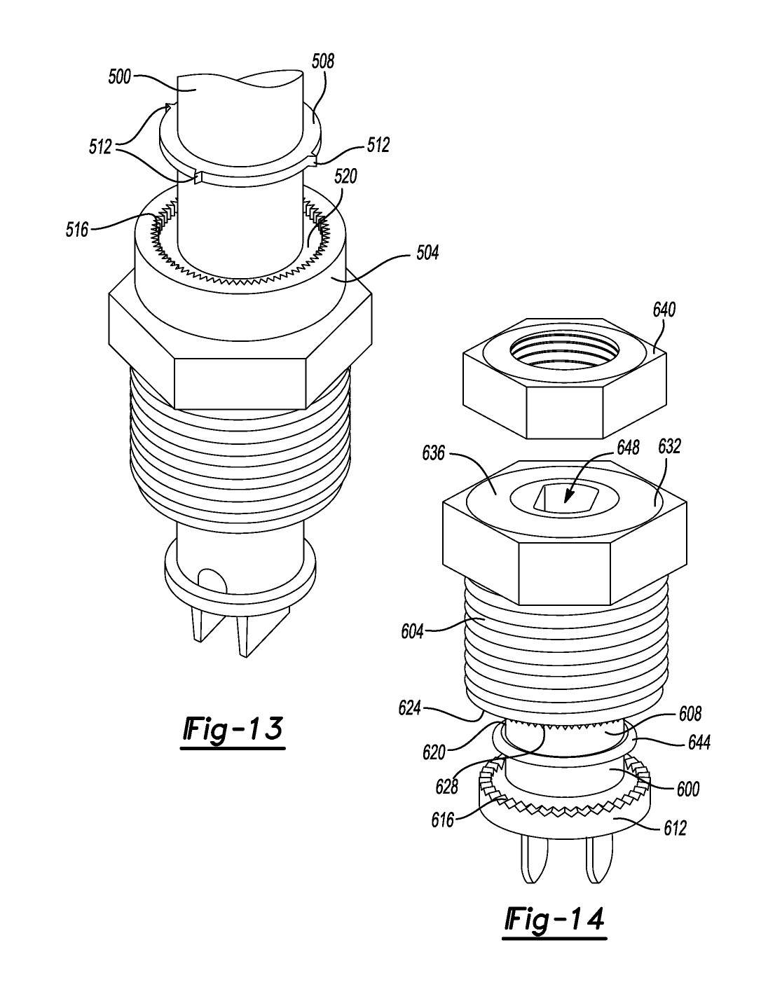

Fitting 404 may be of a tubular shape that is brazed or threaded into the connector 408. The fitting 404 includes a through-hole 450 sharing a longitudinal axis 454 through the center of the through-hole 450 with a longitudinal axis 458 through the center of the fitting 404. The sensor 400 fits within the fitting 404. The fitting 404 further includes a stepped portion 462 having a mating surface 466 that receives the protrusions 442 of the sensor 400. The mating surface 466 may include a positive locator such as indentations 470 (see FIG. 12) or projections that align with the protrusions 442 on the sensor 400 and align the sensor 400 within the fitting 404. The positive locators 470 orient the alignment and depth of the sensor 400 within the fitting 404, and, effectively, within the connector 408. The positive locators 470 may also be continuous around the mating surface 466 (as shown in FIGS. 13 and 14).

When the sensor 400 is set within the fitting 404, the head 418 of the sensor 400 may be flush with the top of the fitting 404, or the head 418 of the sensor 400 may protrude out of the fitting 404.

The fitting 404 may further include a gripping portion 478 for interfacing with a tool (not shown) that tightens the fitting into the connector 408. The gripping portion 478 may be a hexagon or other geometric shape that is different from the cylindrical shape of the fitting 404. The gripping portion 478 may also have an outer diameter that is larger than the outer diameter of the fitting 404 such that the gripping portion 478 protrudes from the outer wall of the fitting 404.

The connector 408 may be a T-shaped pipe connector. The connector 408 may be of a PVC, polyethylene, carbon steel, alloy steel, stainless steel, non-ferrous metal, tempered glass, or any other material known by one skilled in the art. The connector 408 further includes first and second outlets 482, 486 that couple to the portions of cylindrical tube 412, 414. A third outlet 490 receives the fitting 404 and sensor 400. The outlets 482, 486, 490 may be female threaded ends that receive male threaded ends of the portions of cylindrical tube 412, 414 and the fitting 404. The outlets 482, 486, 490 may also be engaged to the portions of cylindrical tube 412, 414 and the fitting 404 through brazing.

As shown in FIG. 12, the sensor 400 is installed such that it reads physical data of fluid flowing within the cylindrical tube 412, 414. The sensor 400 is inserted into the fitting 404 by aligning the protrusions 442 with the projections 470 (or indentations) on the fitting 404. The fitting 404 is brazed or threaded into the third female outlet 490 of the connector 408. The fitting 404 may be aligned within the outlet 490 such that the wings 426, 430 are parallel with a longitudinal axis 494 through the center of the connector 408 between the outlets 482, 486. The fitting 404 may also be aligned such that the wings 426, 430 are at an angle with respect to the longitudinal axis 494. If the wings 426, 430 are at an angle with respect to the longitudinal axis 494, the reading taken by the sensor tip 434 may be different than the reading taken by the sensor tip 434 when the wings 426, 430 are parallel with the longitudinal axis 494. Depending on the fluid, the rate of flow, and the sensitivity desired (as discussed below), it may be desirable to position the wings 426, 430 at an angle with respect to the longitudinal axis 494.

The portions of cylindrical tube 412, 414 are threaded or brazed onto the female outlets 482, 486 of the connector 408.

The sensor 400 may be inserted into the fitting 404 such that the longitudinal axis 446 through the center of the sensor 400 is the same as a longitudinal axis 498 through the center of the outlet 490 of the connector 408. The sensor 400 may also be inserted into the fitting 404 such that the longitudinal axis 446 through the center of the sensor 400 is at an angle relative to the longitudinal axis 498 through the center of the outlet 490 of the connector 408. The angle may be determined based on the sensitivity desired by the sensor 400 and the rate of flow of the fluid in the cylindrical tube 412, 414 (see FIGS. 15a-17b). The sensitivity of the sensor 400 may be dependent on the angle of the sensor tip 434 within the cylindrical tube 412, 414. The position of the sensor tip 434 may also be affected by the flow rate of the fluid (i.e., macroflow vs. microflow). Once the optimal depth and orientation of the sensor 400 is determined, the fitting 404 and connector 408 fix the depth and orientation of the sensor 400.

Now referring to FIG. 13, a sensor 500 may be engaged inside a fitting 504. The sensor 500 may generally include the same features as sensor 400. The sensor 500 and fitting 504 may further include a positive locator for fixing the orientation of the sensor 500 within the fitting 504. For example, the positive locator may be a ring 508 having a plurality of protrusions 512. Each protrusion 512 may mate with one of a plurality of indentations 516 on a mating surface 520 of the fitting 504.

The ring 508 may be formed from a plastic, metal, or any other material known by one skilled in the art. The ring 508 may be fixed to the sensor 500 and may align the sensor 500 in a desired direction relative to flow of a fluid.

The fitting 504 may generally include the same features as fitting 404. The fitting 504 may be threaded or brazed onto a cylindrical tube (not illustrated) or connector (not illustrated). The sensor 500 may be partially inserted into the fitting 504 and aligned. The sensor 500 may then be fully inserted into the fitting 504, inserting the protrusions 512 into the indentations 516 on the mating surface 520, thereby preventing further rotation of the sensor 500 within the fitting 504.

Now referring to FIG. 14, a sensor 600 may be engaged inside a fitting 604. The sensor 600 and fitting 604 may generally include some of the same features as sensor 400 and fitting 404. The sensor 600 may further include a sensor body 608 with an engaging ring 612. The engaging ring 612 may have a diameter that is larger than the diameter of the sensor body 608.

The engaging ring 612 may include a positive locator for fixing the orientation of the sensor 600 within the fitting 604. For example, the positive locator may be a plurality of protrusions 616 (or teeth) and may be in the shape of a gear. The teeth 616 may engage with a mating surface 620 on a first end 624 of the fitting 604. The mating surface 620 may include a positive locator that is a mating gear surface with indentations 628 that receive the teeth 616 on the engaging ring 612.

The sensor 600 may be vertically fixed to the fitting 604 on a second end 632 of the fitting 604. The sensor body 608 may include an engaging portion 636 that protrudes from the second end 632 of the fitting 604 when the sensor 600 is installed in the fitting 604. The engaging portion 636 may be threaded. A nut 640 may secure the sensor 600 in the fitting 604. The nut 640 may have a cross-sectional geometric shape such as a hexagon, octagon, rectangle or any other shape. The hexagon, octagon, and rectangle shapes may be beneficial for gripping the first receiving portion 304 with a tool such as a wrench, vice grips, or pliers.

The sensor 600 may further include a seal 644 (for example, an o-ring) located on the sensor body 608 between the engaging potion 636 and the second end 632 of the fitting 604. The seal 644 may prevent fluid from flowing between the sensor 600 and fitting 604 and may seal the environment in a cylindrical tube (not illustrated) from the external environment.

The fitting 604 may include a through-hole 648 that receives the sensor 600. The sensor 600 may be installed in the fitting 604 by partially inserting the engaging portion 636 of the sensor 600 into the through-hole 648. The sensor 600 is aligned by rotating the sensor 600 within the fitting 604. The sensor 600 is then fully inserted into the fitting 604, and the teeth 616 are engaged with the indentations 628 on the mating surface 620, thereby preventing further rotation of the sensor 600 within the fitting 604. The nut 640 is threaded onto the engaging portion 636 to secure the sensor 600 in the fitting 604.

For example, the sensor 18, 400, 500, 600 may be a water flow sensor (WFS). The depth and angular orientation of the WFS with respect to the direction of the flow has an effect on the repeatability with which flow velocity can be measured. As seen in FIGS. 15a-15c, the sensitivity to the mounting angle is approximately 30 to 70 milliVolts (mV) over 15 angular degrees. By biasing the angular orientation within a predetermined range (for example only, within a range of 0 and 5 degrees), the flow velocity measurement error is minimized. As seen in FIG. 16, the sensitivity to mounting depth is approximately 20 mV to 70 mV per each 6 millimeter change in depth.

Further, flow disturbances affect the sensitivity of the WFS. As seen in FIGS. 17a and 17b, a flow disturbance 6 inches upstream from the sensor has a sensitivity of approximately 20 mV. The voltage out (V-out) of the sensor increases with decreasing distance to an upstream disturbance. The V-out increases 5 mV by a disturbance 18 inches upstream; the V-out increases by 10 mV by a disturbance 12 inches upstream; and the V-out increases by 20 mV by a disturbance 6 inches upstream. The V-out is not affected by a disturbance 6 inches downstream.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mount comprising:
a sensor being configured to output data characterizing the environment;
a first portion having a receiving portion and a first aperture for receiving the sensor,
wherein the receiving portion fixes the sensor to the first portion;
a positive location portion being located on the receiving portion and being adapted to receive the sensor,
wherein the positive location portion and first portion orient the position and depth of the sensor; and
a second portion being removably secured to the first portion to form a clamping structure for retaining the sensor.

2. The mount of claim 1, wherein the sensor includes a threaded portion engaging with a threaded portion of the receiving portion and fixing the sensor in the first aperture.

3. The mount of claim 1, further comprising a cap having a threaded portion on an interior wall that engages with a threaded portion of the receiving portion, wherein the cap covers the sensor and retains the sensor in the first aperture.

4. The mount of claim 1, further comprising a cylindrical tube being clamped between the first portion and the second portion and having a second aperture in a wall of the cylindrical tube, wherein the second aperture receives the sensor.

5. The mount of claim 4, wherein the first portion and the positive location portion orient the sensor within the cylindrical tube.

6. The mount of claim 4, further comprising a seal being located around the sensor and between the first portion and the cylindrical tube for sealing the environment in the cylindrical tube from the external environment.

7. The mount of claim 1, wherein the second portion is slideably removable from the first portion.

8. The mount of claim 7, wherein the second portion includes L-shaped ends and wherein the first portion includes U-shaped ends that envelope the L-shaped ends of the second portion such that the second portion can slide laterally relative to the first portion but is fixed vertically relative to the first portion.

9. The mount of claim 1, wherein the second portion includes a support having a concave shape that secures a cylindrical tube to the first portion and wherein the inner diameter of the support is slightly larger than the outer diameter of the cylindrical tube.

10. The mount of claim 9, further comprising a threaded adjustment rod fixed to the support and extending through a third aperture in the second portion, wherein the threaded adjustment rod is manually twisted to adjust the vertical height of the support relative to the second portion.

11. The mount of claim 1, wherein the first portion and the second portion are secured with a fastener.

12. The mount of claim 1, further comprising a cylindrical tube being clamped between the first portion and the second portion, wherein the second portion is at least one U-bolt being fit around the cylindrical portion and through a plurality of apertures in the first portion.

13. The mount of claim 12, further comprising a plurality of nuts securing each end of the at least one U-bolt to the first portion.

14. The mount of claim 1, wherein the second portion and first portion are hinged on one side such that the second portion is movable at an angle relative to the first portion.

15. The mount of claim 14, wherein the second portion latches to the first portion on a second side such that the second portion is fixed in a position relative to the first portion.

16. The mount of claim 1, further comprising a cylindrical tube being clamped between the first portion and the second portion, wherein the sensor includes a plurality of protrusions mating with a plurality of indentations on the receiving portion to align the position of the sensor relative to flow of a fluid within the cylindrical tube.

17. The mount of claim 16, wherein the position and depth of the sensor is dependent on a speed of the fluid flow, an amount of turbulence in the fluid flow, and the distance of a flow disturbance from the sensor.

18. A mount comprising:
a sensor being configured to output data characterizing the environment;
a fitting having a through-hole and being configured to receive the sensor;
a first positive locator being on the fitting and being adapted to receive a second positive locator on the sensor; and
a connector having a plurality of outlets for receiving the fitting and a plurality of cylindrical portions, wherein the fitting is fixed within the connector;
wherein the first and second positive locators orient the alignment and depth of the sensor within the connector.

19. The mount of claim 18, wherein the sensor includes a plurality of protrusions mating with a plurality of indentations on the fitting to align the position of the sensor relative to flow of a fluid within the connector.

20. The mount of claim 19, wherein the position and depth of the sensor is dependent on a speed of the fluid flow, an amount of turbulence in the fluid flow, and the distance of a flow disturbance from the sensor.

21. The mount of claim 18, wherein the first positive locator is a ring fixed on the sensor and includes a plurality of teeth that mate with a gear on the fitting to align the position of the sensor within the fitting.

22. The mount of claim 18, wherein the first positive locator is a gear with a plurality of teeth that meshingly engage with a gear on the fitting to align the position of the sensor within the fitting.

23. The mount of claim 22, wherein a nut vertically secures the sensor within the fitting and the first and second positive locators rotationally secure the sensor within the fitting.
